(19) United States
(12) Patent Application Publication
(10) Pub. No.: US 2016/0362190 A1
(43) Pub. Date: Dec. 15, 2016

(54) SYNTHETIC VISION

(71) Applicant: INTHEAIRNET, LLC, Irvine, CA (US)

(72) Inventors: Howard Isham ROYSTER, Lafayette, CA (US); Michael J. ROGERSON, Irvine, CA (US); Michelle Chen, Capistrano Beach, CA (US)

(21) Appl. No.: 14/738,259

(22) Filed: Jun. 12, 2015

(51) Int. Cl. B64D 43/00

(52) U.S. Cl. CPC B64D 43/00

(57) ABSTRACT

A synthetic vision system includes a main processor that receives real time telemetry, the main processor retrieving tiles associated with a terrain map based on the real time telemetry, and the main processor processes the tiles corresponding to a mode of display. A rendering processor receives the tiles processed by the main processor, and the rendering processor renders the tiles into synthetic vision image. The rendering processor sends the synthetic vision image to at least one of a primary flight display (PFD), multi-functional display (MFD), and a secondary flight display (SFD). A processor in the at least one of the PFD, MFD, and SFD replaces inactive pixels (black pixels) with pixels of the synthetic vision image such that the synthetic vision image underlays the flight data displayed on the at least one of the PFD, MFD, and SFD.

### BACKGROUND

Field of the Disclosure

The disclosure relates to providing flight images such as synthetic vision (SV), FLIR® camera images, camera images, etc., underlaying a primary flight display (PFD) or on a multi-functional display (MFD)/secondary flight display (SFD), or on an auxiliary cabin display, or a display outside of the aircraft, thereby providing synthetic vision of outside environment.

Background

Pilots of fixed-wing or rotatory wing aircrafts rely on a two-dimensional primary flight display (PFD) or a multi-functional display (MFD) displaying electronic flight data, which are dials and scales depicting altitude, attitude, and airspeed, and as well as yaw, pitch and roll. However, other than, perhaps, the attitude director indicator (ADI) ball showing blue and brown representing the sky and ground, respectively, the PFD or MFD is void of outside terrain information unless the pilot looks out of the windscreen of the aircraft. Further, such two-dimensional information does not provide the pilot with a reality of the outside environment, which may be useful to the pilot in navigating a set course or a detour, as well as avoiding obstacles in the flight path. Furthermore, in outside environmental conditions where visibility is limited, having a synthetically generated visual terrain and obstacle images can greatly enhance a pilot to navigate through the flight path, and in certain instances, without a need for heads-up display (HUD).

### SUMMARY

A synthetic vision system includes a main processor that receives real time telemetry, the main processor retrieving tiles associated with a terrain map based on the real time telemetry, and the main processor processes the tiles corresponding to a mode of display. A rendering processor receives the tiles processed by the main processor, and the rendering processor renders the tiles into synthetic vision image. The rendering processor sends the synthetic vision image to at least one of a primary flight display (PFD), multi-functional display (MFD), and a secondary flight display (SFD). A processor in the at least one of the PFD, MFD, and SFD replaces inactive pixels (black pixels) with pixels of the synthetic vision image such that the synthetic vision image, 2-D, 3-D, FLIR® camera image, camera image, auxiliary image, underlays the flight data displayed on the at least one of the PFD, MFD, and SFD.

### BRIEF DESCRIPTION OF THE DRAWINGS

FIG. 1(a) illustrates an exemplary primary flight display (PFD) according to a known conventional system.

FIG. 1(b) illustrates an exemplary PFD including synthetic vision (SV) according to an embodiment of the present invention.

FIG. 2(a) is a more detailed image of the underlaying SV shown in FIG. 1(b).

FIG. 2(b) is another underlaying SV according to an embodiment of the present invention.

FIG. 2(c) is another underlaying SV according to an embodiment of the present invention.

FIG. 2(d) is a SV showing a perspective view of a terrain according to an embodiment of the present invention.

FIG. 2(e) is a SV showing a perspective view of a terrain having features to avoid obstacles according to an embodiment of the present invention.

FIG. 3 is an exemplary block diagram of a SV system according to an embodiment of the present invention.

FIG. 4 is a more detailed block diagram of a SV system according to an embodiment of the present invention.

FIG. 5 illustrates a main processor according to an embodiment of the present invention.

FIG. 6 illustrates a rendering processor according to an embodiment of the present invention.

### DETAILED DESCRIPTION

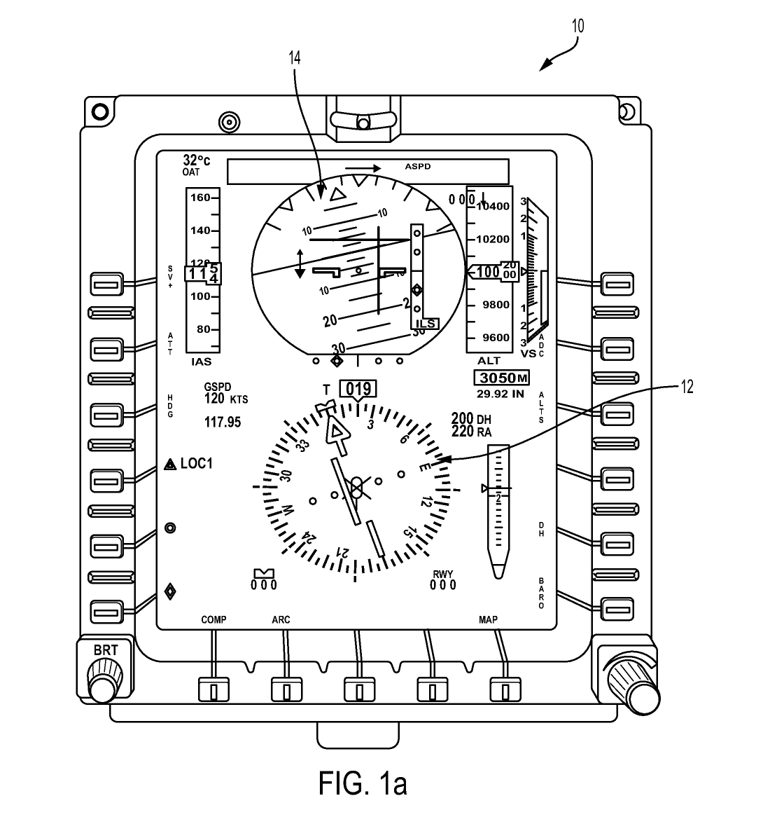

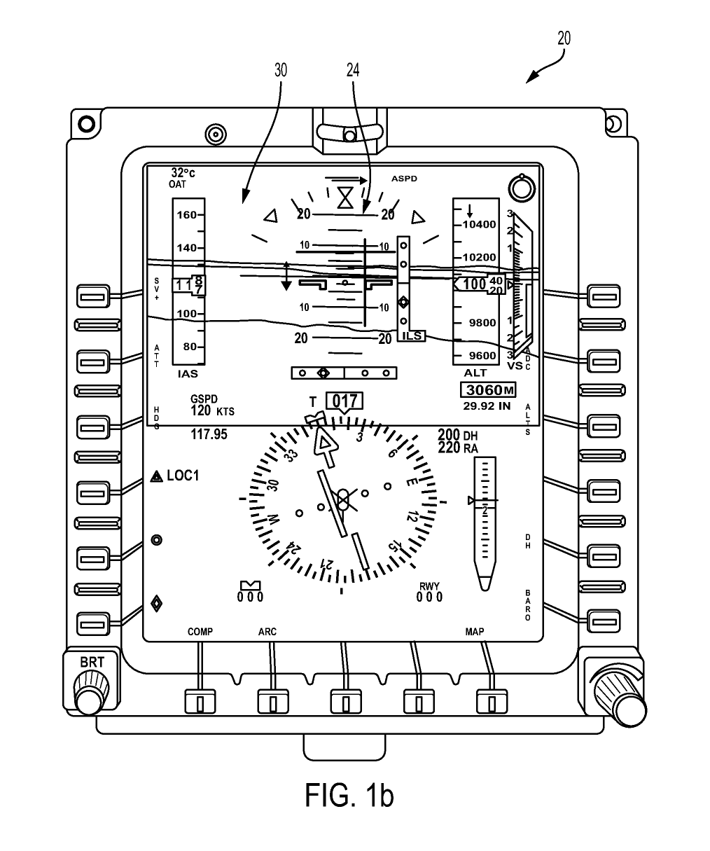

FIG. 1(a) shows an exemplary primary flight display (PFD) 10 according to a known conventional system. The PFD 10 shows at a lower portion of the display an azimuth dial 12 which is a compass showing a direction the aircraft is traveling with respect to the magnetic north. At an upper portion of the display, there is displayed a dial such as an attitude director indicator (ADI) ball 14 and scales showing the altitude, attitude, and airspeed, as well as yaw, pitch and roll. The attitude director indicator (ADI) ball 14 divided to represent the sky and ground. Optionally, surrounding the PFD 10 are numerous selectors that can be manipulated by the pilot to select various display modes of the display unit deemed suitable by the pilot in navigating a flight path or to view various information associated with the flight path, such as weather information, for instance.

Referring now to FIG. 1(b), there is shown an exemplary primary flight display (PFD) 20 including synthetic vision (SV) 30 according to an embodiment of the present invention. The exemplary PFD 20 is similar to that of the conventional PFD 10 shown in FIG. 1(a) except that underlaying the ADI ball 24 and scales at the upper portion of the PFD 20 is a computer generated SV 30, which, for example, may be what the pilot sees outside the windscreen of the aircraft. The SV 30 may provide a visual image of information currently shown by the dials and scales of the conventional PFD 10, and/or additional information that provides additional aid to the pilot in navigating the flight path. In FIG. 1(b), the SV 30 replaces the divided blue and brown color of the ball and in this embodiment, covers most of the upper portion of the PFD 20 to provide more realistic terrain image, but is transparent with respect to the dial and scale at the upper portion of the PFD 20. Stated differently, the SV 30 is underlayed with respect to the dial and scale at the upper portion of the PFD 20 and thus, the dial and scale of the upper portion of the PFD 20 is always visible against the SV 30. In the case of the MFD or a secondary flight display (SFD), the SV may totally replace any information displayed on the display by manipulation of a selector, and may be the sole video image displayed on the display.

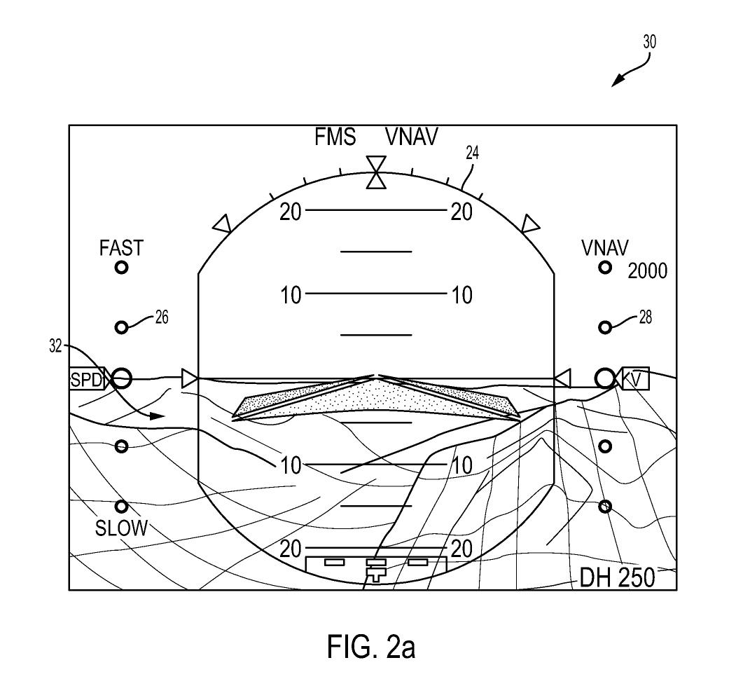

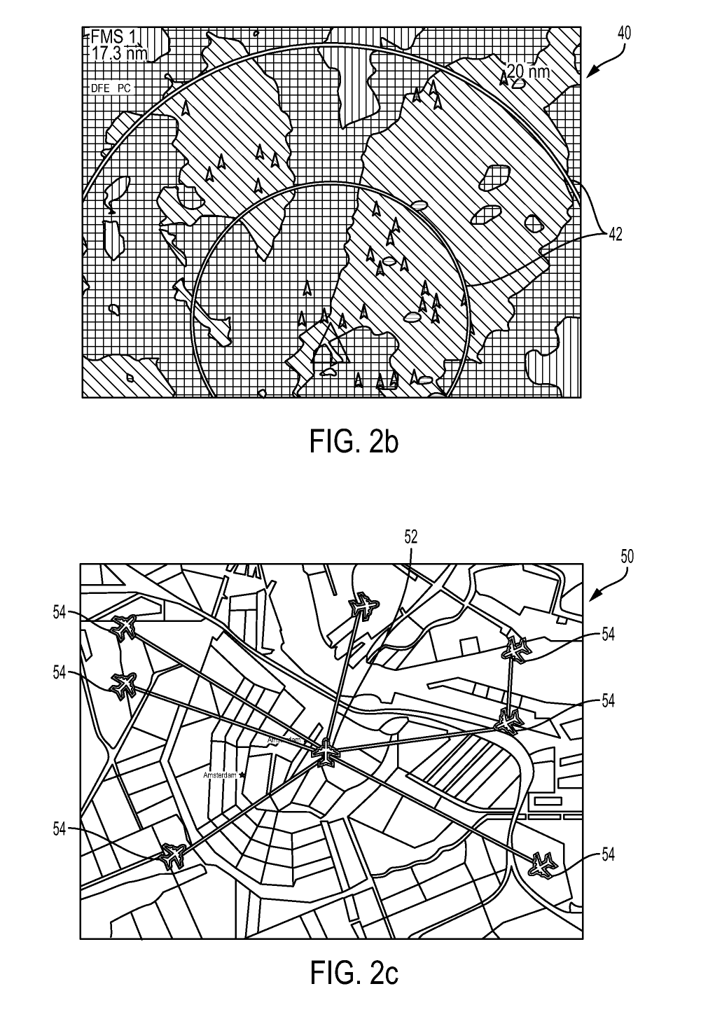

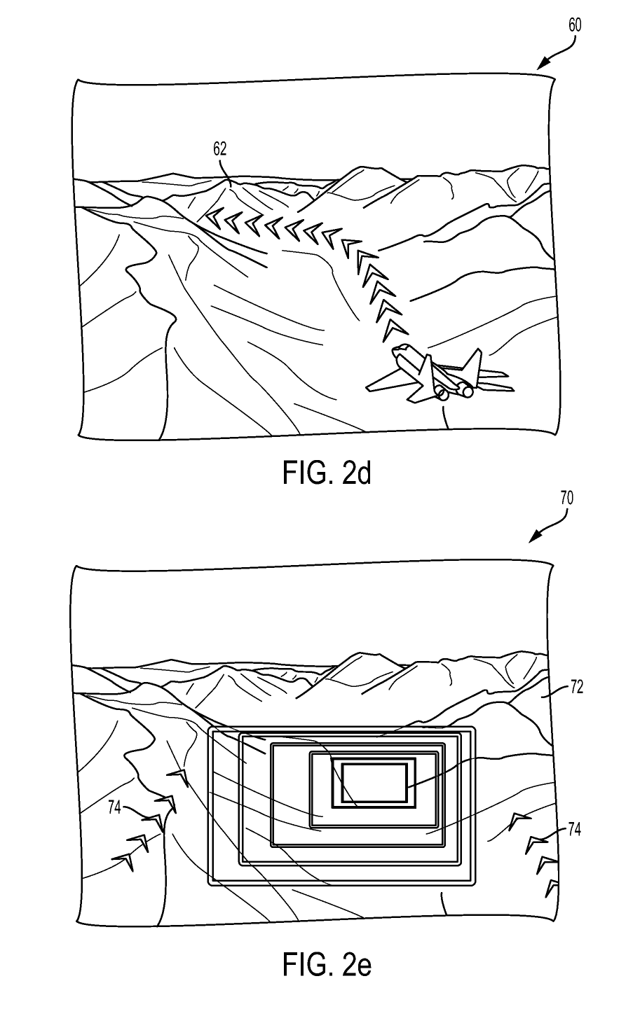

FIG. 2(a) is a more detailed image of the underlaying SV 30 shown in FIG. 1(b). In particular, the underlaying SV 30 is an out-the-windscreen view according to an embodiment of the present invention.

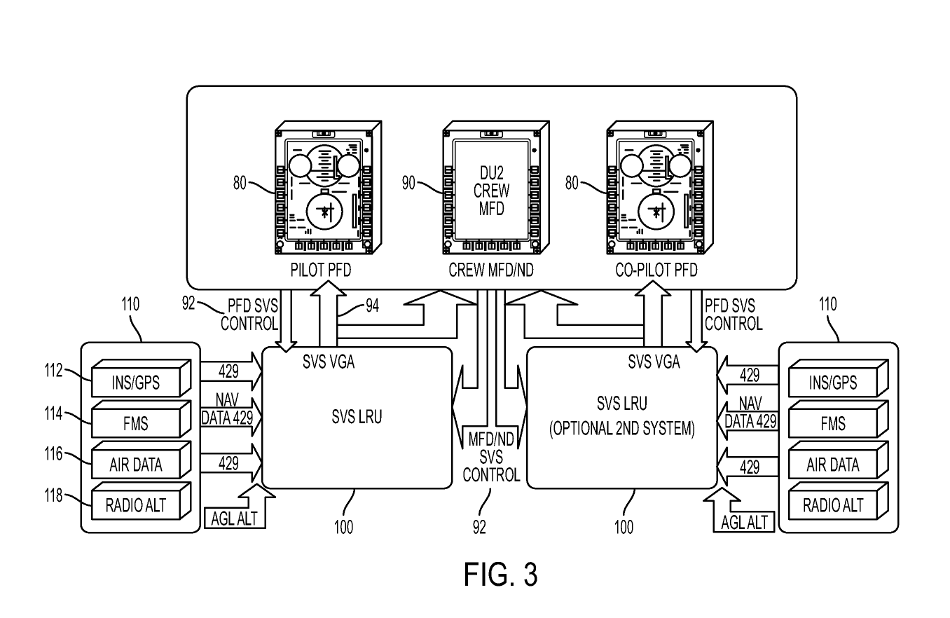

This is a forward looking 3-D image of the terrain as if the pilot would see it directly in front and out the windscreen of the aircraft. The view of the terrain landscape 32 expands out to the horizon within a given field of view. The standard ADI pitch ladder and roll scale markings 24 as well as the airspeed, altitude displays 26, 28 are visible as the 3-D image is underlayed. The 3-D image fills the air data display at the upper portion of the PFD and remain visible behind the airspeed and altitude scales (or round dials) 24, 26, 28, which not be blocked out by black fill (further details will be discussed with respect FIG. 3). According to one embodiment, the vertical speed scale or radio altimeter may be added.

Turning back to the terrain landscape, according to one embodiment, a collision avoidance mode may be implemented in the underlaying SV 30. As an example, when an appropriate selection is made at the selectors, the colors of the terrain and/or obstacles may change based on the distance between the terrain and/or obstacles and the aircraft. The set distance in which the color changes is based on a manufacturer's setting or it can be set by the pilot. As an example, if the mountains in the terrain are greater than 100 miles away from the aircraft, the mountains may appear green. If the aircraft approaches 100 miles or less away from the mountains, the color of the mountains may appear yellow. If the aircraft approaches 50 miles or less away from the mountains, the color of the mountains may appear red. The colors need not be limited to the ones described above, and other colors may be used based on a design criteria. In one embodiment, where an IR camera is installed on the aircraft, the IR image is overlayed with the SV image, but transparent as to the ADI pitch ladders and roll scale marking, based on a selection from the selector. In this instance, the image of the IR camera is synchronized with the SV image such that the IR image matches with the SV image to appear as a single image. In one embodiment, FLIR® camera may be used.

According to another embodiment, the 3-D image properly depicts the terrain image to the pilot such that the pilot can make a determination as to whether the aircraft will clear or not clear the terrain shown ahead. Just positioning terrain relative to the pitch ladder may not be sufficient. Thus in this embodiment, a flight path vector is generated to align the terrain graphics such that the pilot clearly perceives what altitude relative to the terrain the aircraft will be at when it arrives there.

FIG. 2(b) is another underlaying SV 40 according to an embodiment of the present invention. As shown in FIG. 2(b), this is a 2-D view from above the aircraft looking down (top-down view) at the synthetic vision terrain on the horizontal situation indication (HIS) portion (usually the lower portion) of the PFD, or a complete display of the MFD/SFD aligned with the aircraft heading. As shown in the figure, there are range markings 42 and the range may be pilot adjustable as with any plan/map using the selectors, for example, shown in FIG. 1(b), or a full compass rose view may be displayed. Consideration needs to be made for this view regarding the maximum range displayed based upon the size/amount of the terrain data to be depicted for a given level of detail. Given the amount of terrain resolution that is available in the terrain data, the underlaying image may have various magnification levels using the selectors. Of course, this feature would also be available for out-the-windscreen view.

In the event that automatic dependent surveillance—broadcast (ADS-B) data is made available, FIG. 2(c) is another underlaying SV 50 according to an embodiment of the present invention. ADS-B is a technology in which an aircraft broadcasts its location thereby allowing the air traffic control or another aircraft to know the location of the broadcasting aircraft. In an aircraft equipped with “ADS-B out” service, information of an aircraft in the surveillance vicinity, such as identification, current position, altitude, and velocity, for example, in real time, can be ascertained by the ADS-B equipped aircraft. As shown in FIG. 2(c), in the 2-D image, with the ADS-B equipped aircraft 52 at the center of the 2-D image, aircrafts 54 within the surveillance parameter can be depicted in a 2-D image in real time. FIG. 2(c) is shown with a LiDAR image. It should be noted that while FIG. 2(c) depicts a 2-D image, in another embodiment, using a 3-D image rendering processor, a 3-D image can be rendered with the ADS-B equipped aircraft at the center of the 3-D image, and the aircrafts within the surveillance parameter are positioned at the same plane or different planes dependent on that aircraft's altitude with respect to the ADS-B equipped aircraft. Alternatively, the 3-D image rendering processor can generate a perspective view showing the aircrafts are various altitudes and distance from the ADS-B equipped aircraft.

FIG. 2(d) is a SV 60 showing a perspective view of a terrain according to an embodiment of the present invention. As with the SVs described above, this view would be available on the PFD and/or MFD/SFD based on a selection from the selectors. It is similar to the PFD out-the-windscreen view (see, for example, FIG. 2(a)) except that the virtual camera vantage point (point of view) is not from the windscreen (or the nose) of the aircraft. The camera vantage point can be behind, above and to the left or right of the aircraft. FIG. 2(d) depicts a perspective view that is behind and right of the aircraft. The camera vantage point can be fixed in one embodiment, or in an alternative embodiment, the camera vantage point can be manipulated using a selector or a joystick (not shown) to obtain a point of view desired by the pilot. FIG. 2(d) also illustrates mission points 62 generated in the perspective view, which is a feature of the SV 60 according to one embodiment of the present invention. The mission points 62 data may be stored in fixed or removable memory or transmitted to the aircraft in real time.

One aspect of the SV can be to avoid obstacles in the terrain to be navigated. FIG. 2(e) is a SV 70 of a perspective view of a terrain having features to avoid obstacles according to an embodiment of the present invention. In this embodiment, a series of “fly to boxes” 72 centered along the flight path is formed thereby creating a highway-in-the sky (HITS), thereby creating a route which avoids obstacles within the terrain. In this embodiment, the mission points 74 are also present. According to one embodiment, the pilot pilots the aircraft using the mission points 74 shown in the terrain image. When obstacles start appearing on the terrain image, the HITS 72 appear on the terrain image to aid the pilot in guiding through the obstacles. The HITS 72 may be pre-calculated and stored in a memory, or a main processor of the SV system (to be described below) may calculate and generate the HITS 72 based on received flight data and stored terrain maps used to generate SV.

Having these advanced features in addition to the conventional ADI pitch ladder and roll scales may become too compelling to the pilot during the approach phase of flight when focus should be more on conventional data being displayed on the PFD for continued safe flight and landing of the aircraft. Thus, where mandatory, or to comply with regulations, the above-mentioned views can be restricted and automatically removed with approach mode selection, tuning the localizer frequency or some combination of these with radio altitude, for instance.

For implementation of the various “look forward”, “look down”, and perspective images described above that are presented as underlaying images in the upper portions of the PFD or in the MFD/SFD, appropriate database (or databases) and a processor (or parallel processors), preferably, with a graphics engine (processor) able to render 3-D image (for example, 1024×768) with multiple layers at minimum 30 frames per second or better is desirable. However, in another embodiment, the frame rate could be less than 30 frames per second based on a design criteria.

FIG. 3 is an exemplary block diagram of a SV system 100 according to an embodiment of the present invention. The SV system 100 can be part of the PFD 80 or MFD/SFD 90, or can be a separate line replacable unit (LRU). In the exemplary SV system 100 shown in FIG. 3, assuming that the resolution of the display is video graphics array (VGA), VGA inputs are added to the PFD 80 and/or MFD/SFD 90 to interface with the VGA outputs of the SV system 100. In the event that the resolution is high definition (HD) HD inputs and outputs are used. Any resolution may be used based on a design criteria. Generally, appropriate video interfaces will be used so that data signals 94 corresponding to SV can be sent to PFD 80 or MFD/SFD 90. The display of the PFD 80 and/or MFD/SFD 90 can be a CRT, LCD, plasma display, OLED, or the like. That is, any suitable device capable of displaying can be used based on the design criteria.

In one embodiment, there is no physical connection between the SV system 100 and the PFD 80 and/or MFD/SFD 90. The SV system 100 communicates with the PFD 80 and/or MFD/SFD 90 using a wireless connection such as Wi-Fi transmitter/receiver, radio signal transmitter/receiver, IR transmitter/receiver or optocoupler, among others.

The SV display functionality and modes may be selected by the pilot through selectors, which may be hardware switches or softkeys on the display unit of the PFD 80 and/or MFD/SFD 90. This feature eliminates a separate control panel and minimizes manufacturing costs. Where the SV system 100 is separate from the PFD 80 and/or MFD/SFD 90, wired or wireless output interfaces may be added between the PFD 80 and/or MFD/SFD 90 and the SV system 100 so that control signals 92 generated by the manipulation of one or more selectors at the PFD 80 and/or MFD/SFD 90 can be sent to the SV system 100 to be processed.

In one embodiment, the video signals and the control signals are combined to be suitable for transmission over HDMI connector, and the SV system 100 and PFD 80 and/or MFD/SFD 90 are adapted to receive and process HDMI signals. For legacy PFD 80 and/or MFD/SFD 90, transmitted control signals can be converted into HDMI format, and received video signals can be converted from HDMI format to legacy format using a converter installed at the PFD 80 and/or MFD/SFD 90 side.

The SV system 100 receives separately from the PFD 80 or MFD/SFD 90, latitude, longitude, altitude, airspeed, azimuth, yaw, pitch, and roll information, among others. These information may be obtained from ARINC 429 equipment 110, the SV system 100 being wired or wirelessly connected to the ARINC 429 equipment 110 according to various embodiments. As shown in FIG. 3, the ARINC 429 equipment 110 may comprise of various devices such as GPS sensors 112, flight management system 114, air data system 116, radio altimeters 118, among others.

According to one embodiment, the SV system 100 has a fixed or removable memory device contain therein that stores terrain database, obstacle database, and other databases pertinent to generate SV. The SV system 100 is wired or wirelessly connectable to the ARINC 429 equipment 110 to receive flight data and wired or wirelessly connectable to the PFD 80 and/or MFD/SFD 90 to send SV or to receive control signals. Hence, the SV system 100 is portable and can be removed from the aircraft.

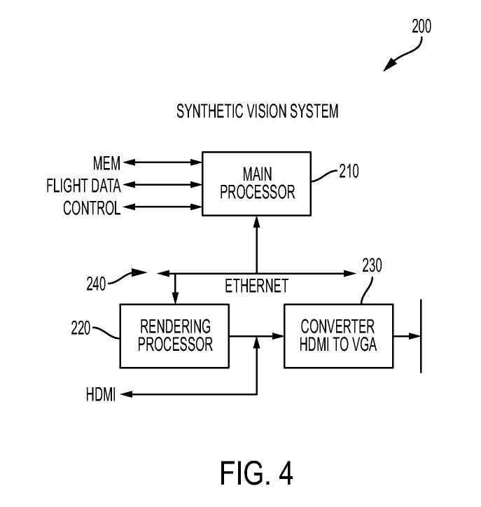

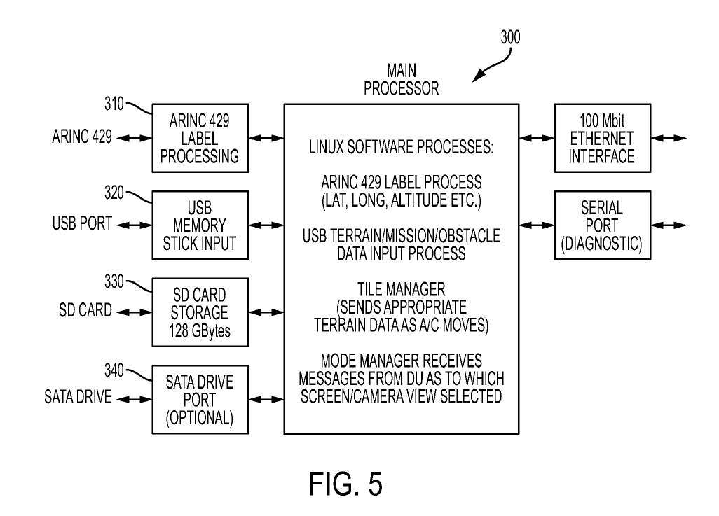

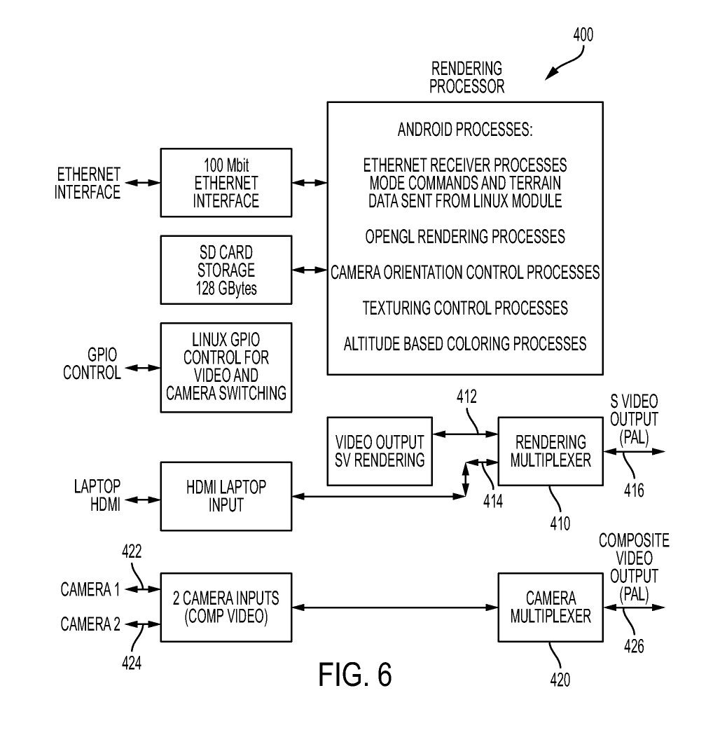

FIG. 4 is a more detailed block diagram of a SV system 200 according to an embodiment of the present invention. The SV system 200 includes a main processor 210, a rendering processor 220, and an optional HDMI/VGA converter 230. The main processor 210 may operate on any known operating system or a proprietary operating system, however in this embodiment, the Linux® operating system is used. The rendering processor 220, likewise, can use any known or proprietary operating system, however, in this embodiment, the Android® operating system is used. The main processor 210 is coupled to an ARINC 429 equipment to receive flight data. The main processor 210 is further coupled to one or more databases stored in memory. The one or more databases may be stored in fixed or removable memory devices, such as semiconductor memories, memory sticks, and/or disk storage devices. The one or more databases may be terrain database, obstacle database, and other database pertinent to generate SV. Based on the flight data, and control signals from the PFD 80 and/or MFD/SFD 100, the main processor 210 generates data representing SV to be rendered. The rendering processor 220 receives the data from the main processor 210 to render images for SV. In this embodiment, the main processor 210 is coupled to the rendering processor 220 via Ethernet 240. However, any bus system may be used. In one embodiment, the main processor 210 is directly coupled to the rendering processor 220 without going through a bus. In another embodiment, the main processor 210 includes a graphics engine that performs the function of the rendering processor 220. The rendering processor 220 also controls the frame rate of the SV. Further details of the main processor 210 and the rendering processor 220 will be described with respect to FIGS. 5 and 6.

In one embodiment, the main processor 210 generates data representing SV to be rendered and transmit to another equipment through the Ethernet 240 wired or wirelessly. As an example, the equipment may be in possessed by a passenger in the cabin of the aircraft. The equipment may be a laptop computer or a PFD/MFD/SFD like device. Having the rendering engine therein, the laptop computer, PFD, MFD, or SFD can generate the same SV on its display like the SV generated on the SFD 80 and/or MFD/SFD 90. Alternatively, the equipment takes the data provided by the SV system and renders a view mode (see FIGS. 2(a)-2(e)) selected by the passenger on the equipment. In this instance, the SV system may provide additional data to accommodate the passenger's selection, for example, such as depth information for 3-D images, mission points, HITS, ADS-B data, and etc. Also, in another embodiment, the passenger may select and receive FLIR® camera images, camera images, or any data inputted or available to the SV system. In another embodiment, the equipment may be a recording equipment that records the data generated by the SV system. In another embodiment, the equipment may be on the ground and the SV system transmits the generated data via a transmitter of the aircraft to the ground equipment to be processed and viewed or recorded.

An optional converter 230 is included when more than one interface format is used in the SV system 200. In this embodiment, the SV system 200 generates HDMI format signals to interface with HDMI compliant devices. The PFD 80 and/or MFD/SFD 90, on the other hand, processes VGA signals. Accordingly, the optional converter 230 converts HDMI format signals into VGA format signals so that the signals can be processed by the PFD 80 and/or MFD/SFD 90.

HDMI compliant devices may be a video monitor, a laptop computer, a tablet, a cellular phone, or any device capable of displaying images generated by the rendering processor 220. While HDMI format is contemplated in this embodiment, in other embodiments USB interface, Ethernet, Wi-Fi interface, or other suitable interfaces may be used.

FIG. 5 illustrates a main processor 300 according to one embodiment of the present invention. Referring now to FIG. 5, the main processor 300 receives from the ARINC 429 equipment 310 real time telemetry such as aircraft latitude, aircraft longitude, barometric altitude, yaw, pitch, roll, heading, ground speed, among others, which will be referred to as ARINC 429 situational data. The main processor 300 processes the labels transmitted by the ARINC 429 equipment 310. Bits 1-8 contain the ARINC label known as the information identifier. Each aircraft will contain a number of different systems, such as flight management computers, inertial reference systems, air data computers, radar altimeters, radios, and GPS sensors, among others. For each type of equipment, a set of labels is defined, which is common to all the equipment. The label can contain instructions or data reporting information. The main processor 300 translates the ARIC 429 situational data into situational data suitable for the rendering processor and transmits to the rendering processor. Based on the ARINC 429 situational data, the main processor 300 retrieves from the one or more databases 320, 330, 340, a terrain map corresponding to the aircraft's position and attitude. For example, the size of the terrain map may correspond to the field of view. In one embodiment, the terrain map is stored in the database as tiles. Based on the mode of view selected (out-the-windscreen view, top-down view, perspective view, 2-D view, 3-D view, for example), the main processor 300 processes and sends the terrain tiles of the retrieved terrain map to the rendering processor.

In one embodiment, the processing of the view is based on a virtual camera concept. The virtual camera is moved in three dimensional space based on the mode of view having, for example, the windscreen of the aircraft as the view from the virtual camera looking at the terrain which is at the center of the three dimensional space. In this embodiment, the x-axis is the direction of the elongated body of the aircraft, the z-axis is perpendicular to the x-axis in the horizontal plane (parallel to the ground), and the y-axis is perpendicular to the x-axis in the vertical plane. In the out-the-windscreen view, the virtual camera is on the x-axis looking at the terrain at the center of the three dimensional space and the main processor processes the tiles based on those coordinates in the three dimensional space. Similarly, in the top-down view, the virtual camera is on the y-axis looking down on the terrain at the center of the three dimensional space, and the main processor processes the tiles based on those coordinates. The perspective view is a selected point in the three dimensional space looking at the terrain at the center of the three dimensional space. The main processor 300 already takes into consideration the aircraft's longitude, latitude, and altitude when generating the tiles of the terrain map. Zooming in would be moving the virtual camera closer to the center of three dimensional space and zooming out would be moving the virtual camera further from the center of three dimensional space. For 2-D view, the main processor 300 does not add depth to the terrain map. For 3-D view, the main processor 300 adds depth to the terrain amp.

The main processor 300 also retrieves obstacle elements and mission points, if any, and transmits to the rendering processor. Where appropriate, the main processor 300 also sends texture and/or coloring tiles for rendering the selected view to the rendering processor. As an example given in FIG. 2(a), when the SV system registers a collision avoidance mode, the main processor 300 may render the mountains green if the mountains in the terrain are greater than 100 miles away from the aircraft. If the aircraft approaches 100 miles or less away from the mountains, the main processor 300 may render the mountains yellow. If the aircraft approaches 50 miles or less away from the mountains, the main processor 300 may render the mountains red. Similarly, the main processor 300 may provide altitude based coloring. As an example, the main processor 300 may render green if the altitude of the aircraft is low. The main processor 300 may render yellow if the altitude is midway. The main processor 300 may render red if the altitude is high.

If the aircraft has the capability, the main processor also receives in real time from an outside source, updates on terrain, obstacles and/or mission points, and updates the one or more databases as necessary. Further details of the one or more databases will described further below.

FIG. 6 illustrates a rendering processor 400 according to an embodiment of the present invention. The rendering processor 400 receives from the main processor 300, the following data, among other. The rendering processor 400 receives real time telemetry of the ARINC 429 situational data. The rendering processor 400 also receives terrain tiles, texture/coloring tiles, and/or obstacles elements suitable for rendering the SV selected for PFD 80 and/or MFD/SFD 90. If mission points data is available, the rendering processor 400 also renders that into the SV. The rendering processor 400 is a graphics engine that renders 2-D/3-D views based on the pilot's selection using the tiles provided by the main processor 300 which have been processed based on the view of the virtual camera also based on the pilot's selection.

The rendering processor 400 renders perspective view or out-the-window view, renders top down view for TCAS like map view (view of the ground beneath the aircraft), renders any object, obstacle, and/or mission points as they appear in the view. The rendering processor 400 renders colors terrain by altitude for elevation view of the terrain. The rendering processor 400 also controls the frame rate so that the pilot does not experience flickering of the SV.

When the SV is transmitted to the PFD, the processor in the PFD underlays the SV with the flight data displayed in the PFD. Referring to FIGS. 1(a) and 1(b), FIG. 1(a) shows at a lower portion of the display an azimuth dial. At an upper portion of the display, there is displayed ADI ladder and scale showing the altitude, attitude, and airspeed, as well as yaw, pitch and roll. However, the remaining area of the display is black. If a pixel of the SV coincides with a black pixel (inactive pixel) of the black area, the processor activates the pixel to the pixel of the SV. In so doing, the SV is underlayed with the flight data as shown in FIG. 1(b). In FIG. 1(b) the blue and brown of the ADI ball is also replaced by the pixels of the SV. In this manner, the SV does not interfere with any flight data of the PFD.

FIG. 6. further includes additional features that are implemented in the SV system according to one embodiment of the present invention. According to the embodiment, the SV system includes a rendering multiplexer 410 having a first input 412 and a second input 414. While two inputs are shown, the rendering multiplexer 410 can have more than two inputs based on a design criteria. At the first input 412, the rendering multiplexer 410 receives SV rendered by the rendering processor 400. The second input 414 is coupled to, in this example, a laptop computer having mission data or “electronic flight bag”, which is a device that allows the pilot to perform a variety of functions that were previously accomplished using paper references. The output 416 of the rendering multiplexer 410 is wired or wirelessly connected to the PFD and/or MFD/SFD. While the laptop computer or the electronic flight bag is connected wired or wirelessly to the SV system, by selection from the selector at the PFD and/or MFD/SFD, the main processor 300 causes the rendering multiplexer 410 to connect the output 416 to the second input 414 of the rendering multiplexer 410. The data/image at the laptop computer or at the electronic flight bag is displayed on the PFD and/or MFD/SFD. The display format will be similar to that of SV shown in FIG. 1(b), which is the upper portion of the PFD, or it could be displayed at the lower portion of the PFD, or it could be displayed covering the full display of the MFD/SFD.

According to the embodiment, the SV system includes a camera multiplexer 420 having a first input 422 and a second input 424. While two inputs are shown, the camera multiplexer 420 can have more than two inputs based on a design criteria. Camera 1 is connected to the first input 422 and camera 2 is connected to the second input 424. For example, the camera could be a still-image camera, a video camera, an IR camera, or any camera, its function for which the camera was installed for. an output 426 of the camera multiplexer 426 is wired or wirelessly connected to the PFD and/or MFD/SFD. By selection from the selector at the PFD and/or MFD/SFD, the main processor 300 causes the camera multiplexer 426 to connect camera 1 or camera 2 to the output 426 of the camera multiplexer 420 depending on whether camera 1 or camera 2 was selected. The image or images captured by the selected camera is displayed on the PFD and/or MFD/SFD. The display format will be similar to that of SV shown in FIG. 1(b), which is the upper portion of the PFD, or it could be displayed at the lower portion of the PFD, or it could be displayed covering the full display of the MFD/SFD. In one embodiment, a camera is selected by the main processor 300 and displayed on the PFD and/or MFD/SFD based on certain maneuvers detected by the SV system.

As an example, maneuvers taken by a helicopter will be used to explain the above-noted feature of the embodiment. The SV system is connected to one or more motion sensors (not shown) that detect the maneuvers of the helicopter. When the SV system detects any of these maneuvers, the main processor causes the camera multiplexer to switch to the camera taking images from the aircraft to the ground and outputs those images to the PFD and/or MFD/SFD to be displayed. The camera may video camera or IR camera. The camera may be a gimbal camera rotatable about single-axis, two-axis, or three-axis. In the case of the gimbal camera, the main processor will cause the gimbal camera to direct the camera towards the ground.

Takeoff

Maneuvers include vertical ascent, nose pitch down, maximum acceleration/ascent, nose-up to 5 degree below horizontal for forward acceleration.

Landing

Maneuvers include slow down, nose up, hover, vertical descent.

Hover

a) Maneuvers include yaw once around/360 degree clockwise, stop and yaw counterwise 360 degree.

b) Maneuvers include fly forward and curve/yaw right (also roll) 360 degree once around.

c) Maneuvers include fly forward and curve/yaw left (also roll) 360 degree once around.

d) Maneuvers include low speed forward, turn/yaw-roll right, turn/yaw-roll left, low speed aft (nose up).

Various databases may be available to the main processor depending on the 2-D/3-D images to be rendered. The database/databases may be an integration of layered functionality containing different sets of data whether it is developed in-house or obtained through 3^{rd} party sources as a subscription. Multiple database sources should be considered for 2-D/3-D rendering flexibility. Maps with obstacles may change over time and regular database maintenance may be required. An obstacle database may best be served through a subscription.

Terrain Data

The terrain database is to have 100% worldwide coverage with a target resolution of 3 to 6 arc-seconds or better. Latitude and Longitude is measured in degrees, minutes and seconds and on the surface of a sphere the path is curved (e. g. an arc), so arc-seconds is an industry term. One arc-second is approximately 100 feet, so 6 arc-seconds will correspond to 600 feet resolution. The resolution of a terrain database is not the same worldwide. Typical numbers to obtain are data points every 2 mile worldwide, at least mile between the latitudes of 30 degrees and 40 degrees and approximately 1/10 of a mile (every 600 feet) at airports where mountainous terrain exists. Data sources with this coverage and resolution are available. Grid lines should be applied to the terrain every ¼ nmi from east to west and nmi from north to south (at the equator).

Cultural Features

Large bodies of waterways, such as lakes and rivers are to be included. Roads, railways or forests may be a customer driven option.

Airports

10,000 airports, 18,000 runways and approximately 7,000 heliports can be made available worldwide.

Obstacles

30,000 to 120,000 FAA NACO low altitude obstacles should be made available as an option. To help reduce clutter, obstacles may only pop-up when within 1,000 feet of the aircraft's altitude. This data may not be worldwide.

LiDAR Image Data

LiDAR data should be used to enhance the terrain image where available by draping the LiDAR image over the terrain generated image. This data may not be worldwide.

Sources of Database Information

Various sources of data are available.
NOAA—National Oceanic and atmospheric Administration, probably the first available source used by the industry.
NOAA is also a source for LiDAR imagery. Although 100% coverage over the globe is not yet available, it is expanding. LiDAR resolution is so good that it is measured in fractions of an arc-second (1 arc-second=30 meters) and the accuracy is measured in feet.
Space Shuttle Data—This mapping data was first available in the 2002/2003 timeframe and does contain better than 6 arc-seconds resolution and is believed to be 3 arc-seconds for most locations. It was available for purchase on CD ROM at that time.
Aerial Photography—may be used to enhance the imaging at specific locations such as airports. This data is labor intensive, seldom updated and expected to be expensive to obtain.
Satellite Imaging—While highly desired, it may be available in the future.
Jeppesen Database/Subscription—This database is generated from 3 arc-second space shuttle data and now has 50 meter horizontal accuracy and 30 meter vertical accuracy. Obstacle data is also available from Jeppesen.
FAA DOF—The FAA has a digital obstacle data file for the US.

Although embodiments have been described with reference to a number of illustrative embodiments thereof, which can be mixed to achieve a SV system suitable for the tasks for which the SV system is designed, it should be understood that numerous other modifications and embodiments can be devised by those skilled in the art that will fall within the spirit and scope of the principles of this disclosure.

What is claimed is:

1. A synthetic vision system comprising:
a main processor that receives real time telemetry, the main processor retrieving tiles associated with a terrain map based on the real time telemetry, the main processor processing the tiles corresponding to a mode of display;
a rendering processor that receives the tiles processed by the main processor, the rendering processor rendering the tiles into synthetic vision image, the rendering processor sending the synthetic vision image to at least one of a primary flight display (PFD), multi-functional display (MFD), and a secondary flight display (SFD), wherein a processor in the at least one of the PFD, MFD, and SFD replaces inactive pixels (black pixels) with pixels of the synthetic vision image such that the synthetic vision image underlays the flight data displayed on the at least one of the PFD, MFD, and SFD.
